(19) United States
(12) Patent Application Publication
(10) Pub. No.: US 2017/0204880 A1
(43) Pub. Date: Jul. 20, 2017

(54) Fan Installation Kit

(71) Applicant: William Le Blanc, Westminister, CO (US)

(72) Inventor: William Le Blanc, Westminister, CO (US)

(21) Appl. No.: 15/002,052

(22) Filed: Jan. 20, 2016

(51) Int. Cl. F04D 29/64; F04D 25/08; F04D 27/00; H01R 24/20; F21V 33/00; F21V 23/00; H02K 11/00; H02G 3/34; F04D 25/06; F04D 29/32

(52) U.S. Cl. CPC F04D 29/644; F04D 25/0693; F04D 25/088; F04D 27/004; F04D 29/325; F21V 33/0096; F21V 23/003; H02K 11/0094; H02G 3/34; H01R 24/20; H01R 2103/00

(57) ABSTRACT

A fan installation kit for installing a fan in a finished room includes a fan. The fan comprises a motor and a receiver. The receiver is operationally coupled to the motor. A power cord has a first end and a second end. The first end is electrically couplable to the motor. A coupler is electrically coupled to the second end of the power cord. The coupler is configured for coupling the motor to an alternating current power source. A controller is wirelessly coupled to the receiver of the fan. The controller is positioned to send on/off commands to the motor. The fan is configured for coupling to a ceiling with the first end of the power cord configured for coupling to the motor. The coupler is configured for insertion into a switch controlled outlet. The controller is positioned to wirelessly signal the receiver to turn the motor on and off.

### BACKGROUND OF THE DISCLOSURE

### Field of the Disclosure

The disclosure relates to fan installation kits and more particularly pertains to a new fan installation kit for installing a fan in a finished room.

### SUMMARY OF THE DISCLOSURE

An embodiment of the disclosure meets the needs presented above by generally comprising a fan. The fan comprises a motor and a receiver. The receiver is operationally coupled to the motor. A power cord has a first end and a second end. The first end is electrically couplable to the motor. A coupler is electrically coupled to the second end of the power cord. The coupler is configured for coupling the motor to an alternating current power source. A controller is wirelessly coupled to the receiver of the fan. The controller is positioned to send on/off commands to the motor. The fan is configured for coupling to a ceiling with the first end of the power cord configured for coupling to the motor. The coupler is configured for insertion into a switch controlled outlet. The controller is positioned to wirelessly signal the receiver to turn the motor on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a fan installation kit according to an embodiment of the disclosure.

FIG. 2 is a detail view of an embodiment of the disclosure.

FIG. 3 is a cross-sectional view of an embodiment of the disclosure.

FIG. 4 is a side view of an embodiment of the disclosure.

### DESCRIPTION OF THE PREFERRED EMBODIMENT

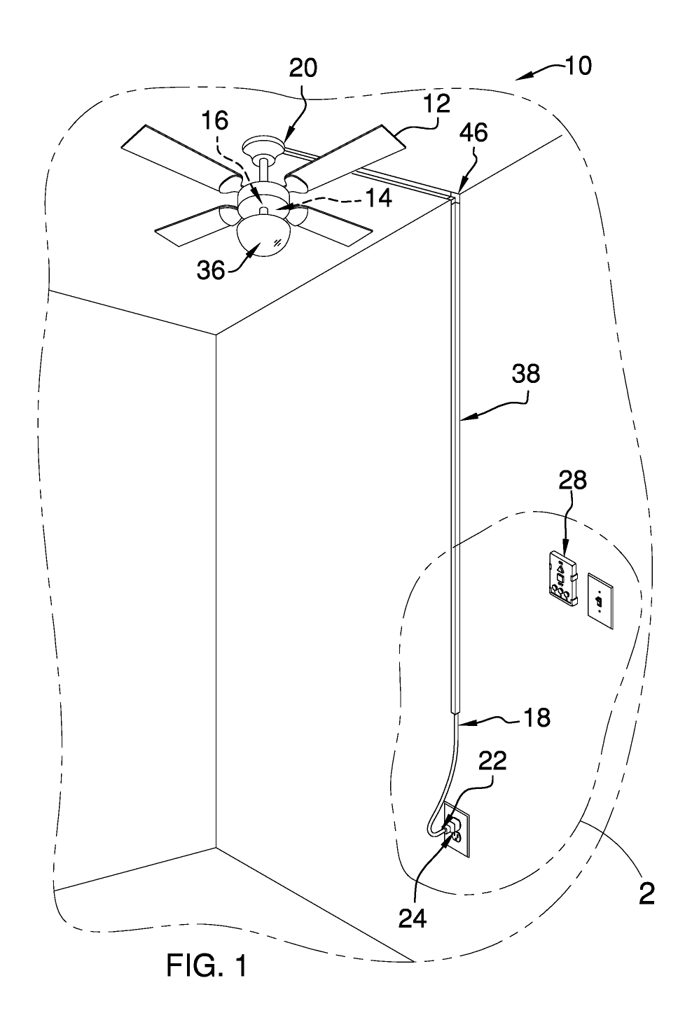

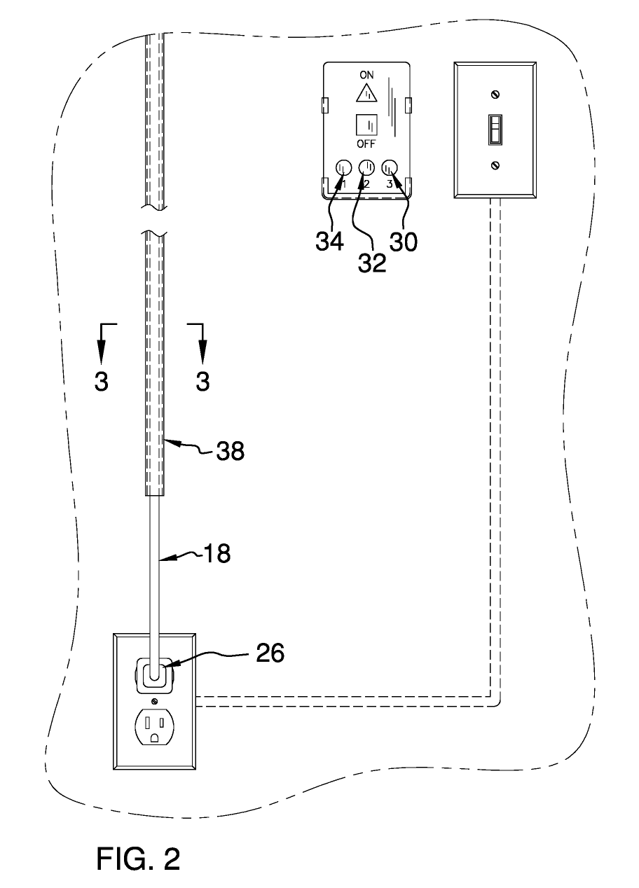

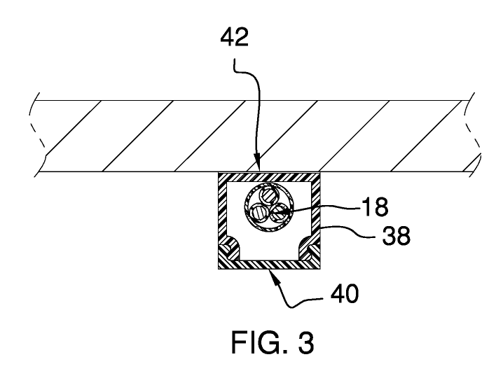

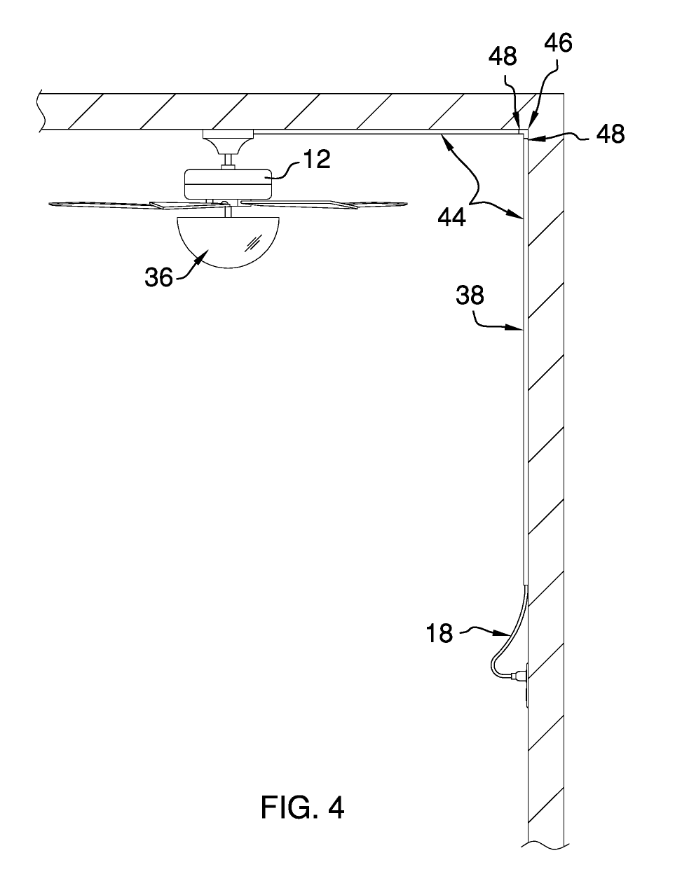

With reference now to the drawings, and in particular to FIGS. 1 through 4 thereof, a new fan installation kit embodying the principles and concepts of an embodiment of the disclosure and generally designated by the reference numeral 10 will be described.

As best illustrated in FIGS. 1 through 4, the fan installation kit 10 generally comprises a fan 12. The fan 12 comprises a motor 14 and a receiver 16. The receiver 16 is operationally coupled to the motor 14.

The kit 10 comprises a power cord 18 that has a first end 20 and a second end 22. The first end 20 is electrically couplable to the motor 14. A coupler 24 is electrically coupled to the second end 22 of the power cord 18, such that the coupler 24 is configured to coupling the motor 14 to an alternating current power source. The coupler 24 is selected from the group of plug types consisting of plug Types A, B, C, D, E, F, G, H, I, J, K, L, M, N, and O. Preferably, the coupler 24 comprises a Type B plug 26.

The kit 10 also comprises a controller 28 that is wirelessly coupled to the receiver 16 of the fan 12. The controller 28 is positioned to send on/off commands through the receiver 16 to the motor 14. Preferably, the controller 28 is positioned to send speed commands through the receiver 16 to the motor 14. More preferably, the controller 28 comprises a high speed button 30, a medium speed button 32, and a low speed button 34.

The fan 12 may comprise a light 36. The controller 28 is positioned to send on/off commands through the receiver 16 to the light 36. The light 36 may be dimmable.

The kit 10 also comprises a raceway 38. The raceway 38 is configured for insertion and retention of the power cord 18. The raceway 38 conceals the power cord 18 for at least of portion of the distance between the fan 12 and a switch controlled outlet. Preferably, the raceway 38 is substantially rectangular when viewed longitudinally.

The raceway 38 has a front face 40 and a back face 42. The back face 42 is configured for attachment to a flat surface. The raceway 38 is configured to attach to the ceiling adjacent to the fan 12 such that the power cord 18 is concealed between the fan 12 and a wall housing the switch controlled outlet. The raceway 38 also is configured to attach to the wall housing the switch controlled outlet such that the power 18 cord is concealed between the ceiling and the switch controlled outlet. The front face 40 is removable and reattachable. The front face 40 is configured to be removed for insertion of the power cord 18 and reattached to retain and conceal the power cord 18.

The raceway 38 may comprise a plurality of sections 44 and the kit 10 may comprise a plurality of elbows 46. The elbows 46 are complementary to the raceway 38, such that each elbow 46 is couplable to respective ends 48 of adjacent sections 44 of the raceway 38. The adjacent sections 44 are transversely positionable in an elbow 46, such that the elbows 46 provide connectivity and concealment between the adjacent sections 44.

In use, the fan 12 is configured to couple to a ceiling with the first end 20 of the power cord 18 coupled to the motor 14. The raceway 38 is configured to couple to the ceiling and wall between the fan 12 and a switch controlled outlet, with the power cord 18 being positioned in and concealed by the raceway 38. The coupler 24 is configured for insertion into the switch controlled outlet. The controller 28 is positioned to wirelessly signal the receiver 16 to turn the motor 14 on and to turn the motor 14 off. The high speed button 30, medium speed button 32 and low speed button 34 can be depressed by the user to control the speed of the fan 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A fan installation kit comprising:
a fan, said fan comprising a motor and a receiver, said receiver being operationally coupled to said motor;
a power cord, said power cord having a first end and a second end, said first end being electrically couplable to said motor;
a coupler, said coupler being electrically coupled to said second end of said power cord, wherein said coupler is configured for coupling said motor to an alternating current power source;
a controller, said controller being wirelessly coupled to said receiver of said fan, said controller being positioned to send on/off commands through said receiver to said motor; and
wherein said fan is configured for coupling to a ceiling, such that said first end of said power cord is configured for coupling to said motor and said coupler is configured for insertion into a switch controlled outlet, and wherein said controller is positioned to wirelessly signal said receiver to turn said motor on and to turn said motor off.

2. The kit of claim 1, further including said coupler being selected from the group of plug types consisting of plug Types A, B, C, D, E, F, G, H, I, J, K, L, M, N, and O.

3. The kit of claim 1, further including said coupler comprising a Type B plug.

4. The kit of claim 1, further including said controller being positioned to send speed commands through said receiver to said motor.

5. The kit of claim 4, further including said controller comprising a high speed button, a medium speed button, and a low speed button.

6. The kit of claim 1, further including said fan comprising a light.

7. The kit of claim 6, further including said controller being positioned to send on/off commands through said receiver to said light.

8. The kit of claim 6, further including said light being dimmable.

9. The kit of claim 1, further including a raceway, said raceway being configured for insertion and retention of said power cord, wherein said raceway conceals said power cord for at least of portion of the distance between said fan and a switch controlled outlet.

10. The kit of claim 9, further including said raceway being substantially rectangular when viewed longitudinally.

11. The kit of claim 10, further including said raceway having a front face and a back face, said back face being configured for attaching to a flat surface, wherein said raceway is configured to attach to the ceiling adjacent to said fan such that said power cord is concealed between said fan and a wall housing the switch controlled outlet, and wherein said raceway is configured to attach to the wall housing the switch controlled outlet such that said power cord is concealed between a ceiling and the switch controlled outlet.

12. The kit of claim 11, further including said front face being removable and reattachable, wherein said front face is configured to be removed for insertion of said power cord and reattached to retain and conceal said power cord.

13. The kit of claim 9, further including said raceway comprising a plurality of sections.

14. The kit of claim 13, further including a plurality of elbows, said elbows being complementary to said raceway, wherein each said elbow is couplable to respective ends of adjacent said sections of said raceway such that said sections are transversely positionable, wherein said elbows provide connectivity and concealment between said adjacent said sections.

15. A fan installation kit comprising:
a fan, said fan comprising a motor and a receiver, said receiver being operationally coupled to said motor;
a power cord, said power cord having a first end and a second end, said first end being electrically couplable to said motor;
a coupler, said coupler being electrically coupled to said second end of said power cord, wherein said coupler is configured for coupling said motor to an alternating current power source, said coupler being selected from the group of plug types consisting of plug Types A, B, C, D, E, F, G, H, I, J, K, L, M, N, and O; said coupler comprising a Type B plug;
a controller, said controller being wirelessly coupled to said receiver of said fan, said controller being positioned to send on/off commands through said receiver to said motor, said controller being positioned to send speed commands through said receiver to said motor, said controller comprising a high speed button, a medium speed button, and a low speed button;
said fan comprising a light;
said controller being positioned to send on/off commands through said receiver to said light, said light being dimmable;
a raceway, said raceway being configured for insertion and retention of said power cord, wherein said raceway conceals said power cord for at least of portion of the distance between said fan and a switch controlled outlet;
said raceway being substantially rectangular when viewed longitudinally, said raceway having a front face and a back face, said back face being configured for attaching to a flat surface, wherein said raceway is configured to attach to the ceiling adjacent to said fan such that said power cord is concealed between said fan and a wall housing the switch controlled outlet, and wherein said raceway is configured to attach to the wall housing the switch controlled outlet such that said power cord is concealed between a ceiling and the switch controlled outlet, said front face being removable and reattachable, wherein said front face is configured to be removed for insertion of said power cord and reattached to retain and conceal said power cord, said raceway comprising a plurality of sections;
a plurality of elbows, said elbows being complementary to said raceway, wherein each said elbow is couplable to respective ends of adjacent said sections of said raceway such that said sections are transversely positionable, wherein said elbows provide connectivity and concealment between said adjacent said sections; and
wherein said fan is configured for coupling to a ceiling, such that said first end of said power cord is configured for coupling to said motor and said coupler is configured for insertion into a switch controlled outlet, and wherein said controller is positioned to wirelessly signal said receiver to turn said motor on and to turn said motor off.
